(19) United States
(12) Patent Application Publication
(10) Pub. No.: US 2017/0279384 A1
(43) Pub. Date: Sep. 28, 2017

(54) MOTOR CONTROL SYSTEM AND METHOD

(71) Applicant: Purdue Research Foundation, West Lafayette, IN (US)

(72) Inventor: Abdullah Eroglu, Fort Wayne, IN (US)

(73) Assignee: Purdue Research Foundation, West Lafayette, IN (US)

(21) Appl. No.: 15/470,898

(22) Filed: Mar. 27, 2017

Related U.S. Application Data
(60) Provisional application No. 62/313,754, filed on Mar. 27, 2016.

(51) Int. Cl. H02P 6/14; F25B 49/02; F24F 11/00

(52) U.S. Cl. CPC H02P 6/14; F24F 11/0079; F25B 49/025; F25B 2600/11

(57) ABSTRACT

A motor control interface system, comprising an interface communication module configured to connect to a wired control port of a rotating electronically controlled motor, such as in an HVAC system, wherein the interface communication module converts a rotating motor speed signal to a wireless signal for receipt by an external monitoring device. The speed output signal comprises a digital square wave signal, and the communication module implements a reciprocal frequency counter method to determine the speed of the motor. The interface communication module wirelessly transmits the motor speed information to a handheld wireless device, such as a smartphone.

### CROSS-REFERENCE TO RELATED APPLICATIONS

The present patent application is related to and claims the priority benefit of U.S. Provisional Patent Application Ser. No. 62/313754, filed Mar. 27, 2016, the contents of which is hereby incorporated by reference in its entirety into the present disclosure.

### TECHNICAL FIELD

The present application relates to motors and associated control systems, and more specifically, to an HVAC and refrigeration motor control system having wireless communication capability.

### BACKGROUND

Fractional horsepower electrically commutated motors (ECM's) are used in a variety of heating ventilation and air-conditioning (HVAC) and refrigeration applications. ECMs power mostly fans, which in turn move air over coils or compressors for the purpose of cooling. Although ECM's provide a large step forward in efficiency over induction and PSC motors, there is yet more efficiency to be had by introducing “smarter” technology into ECM's.

The most current, front running design in the HVAC systems and refrigeration units is a motor unit that can be used in many applications requiring many different speeds. Currently, this motor requires a plug in handheld device which requires a technician to manually observe the speed of the motor and then change it. To do this, access to the back of the motor is required to connect the speed change unit. This speed change unit is also a separate unit that must be purchased along with the motor. The second option would be to purchase an expensive customized control unit for the motor.

The main objective of maintenance personnel who maintain the cooling units with these fan motors is to get a running motor into the unit where one has failed. They do not focus on what speed the new motor is running, just that it is running. Due to this fact, the unit may not be cooling as efficiently as it can if the new motor is not running the right speed specified by its manufacturer. Therefore, improvements are needed in the field.

### SUMMARY

The present disclosure provides a wireless data acquisition system for control and diagnostic of electronically commutated motors (ECMs) that can lead to energy and cost savings with improved electric machine parameters. The system is configured to work in conjunction with ECMs which have been widely used in heating, ventilating, and air conditioning (HVAC) systems, and cooling and refrigeration units. The system may be modular and includes a generic interface circuit and software platform which can be wirelessly controlled by smart phones using both an android and IOS platform. The system enables users to be able to control several important electric machine performance parameters such as speed and temperature, in order to obtain significant energy and cost savings. Furthermore, the system can be easily interfaced with existing commercial ECMs.

The system provides several benefits including cost and energy savings, and eliminates the need for the manual control and periodic maintenance by technicians of the ECMs that are within millions of residential and industrial HVAC systems, and refrigeration and cooling units in stores and homes. It also gives manufacturers the ability to remotely monitor the status of their installed products over predefined networks.

According to one aspect, a motor control interface system is provided, comprising an interface communication module configured to connect to a wired control port of a rotating electronically controlled motor, wherein the interface communication module converts a rotating motor speed signal to a wireless signal for receipt by an external monitoring device, wherein the speed output signal comprises a digital square wave signal, and wherein the communication module implements a reciprocal frequency counter method to determine the speed of the motor.

According to another aspect, a method for controlling an electronically controlled motor is provided, comprising wirelessly outputting a rotating motor speed signal from an interface communication module connected to a wired control port of a rotating electronically controlled motor, wherein the interface communication module converts the rotating motor speed signal to a wireless signal for receipt by an external monitoring device, wherein the speed output signal comprises a digital square wave signal, and wherein the interface communication module implements a reciprocal frequency counter method to determine the speed of the motor.

### BRIEF DESCRIPTION OF THE DRAWINGS

In the following description and drawings, identical reference numerals have been used, where possible, to designate identical features that are common to the drawings.

FIG. 1a is a top view of an interface system installed in a housing of a commercially-available ECM according to various aspects.

FIG. 1b is a perspective view of an interface system installed in a housing of a commercially-available ECM according to various aspects.

FIG. 2 is an example of a communication module layout within a plastic enclosure according to various aspects.

FIG. 3 is a schematic of a switching regulator circuit for use with the interface system according to various aspects.

FIG. 4 is an example of a voltage translator circuit for use with the interface system according to various aspects.

FIG. 5 show an example data transmission signal according to various aspects.

FIG. 6 shows a sample circuit diagram for the interface system according to various aspects.

FIG. 7 shows a sample PCB board layout for the interface system according to various aspects.

FIG. 8 shows an example of a manufactured PCB board for the interface system (without components populated).

The attached drawings are for purposes of illustration and are not necessarily to scale.

### DETAILED DESCRIPTION

In the following description, some aspects will be described in terms that would ordinarily be implemented as software programs. Those skilled in the art will readily recognize that the equivalent of such software can also be constructed in hardware, firmware, or micro-code. Because data-manipulation algorithms and systems are well known, the present description will be directed in particular to algorithms and systems forming part of, or cooperating more directly with, systems and methods described herein. Other aspects of such algorithms and systems, and hardware or software for producing and otherwise processing the signals involved therewith, not specifically shown or described herein, are selected from such systems, algorithms, components, and elements known in the art. Given the systems and methods as described herein, software not specifically shown, suggested, or described herein that is useful for implementation of any aspect is conventional and within the ordinary skill in such arts.

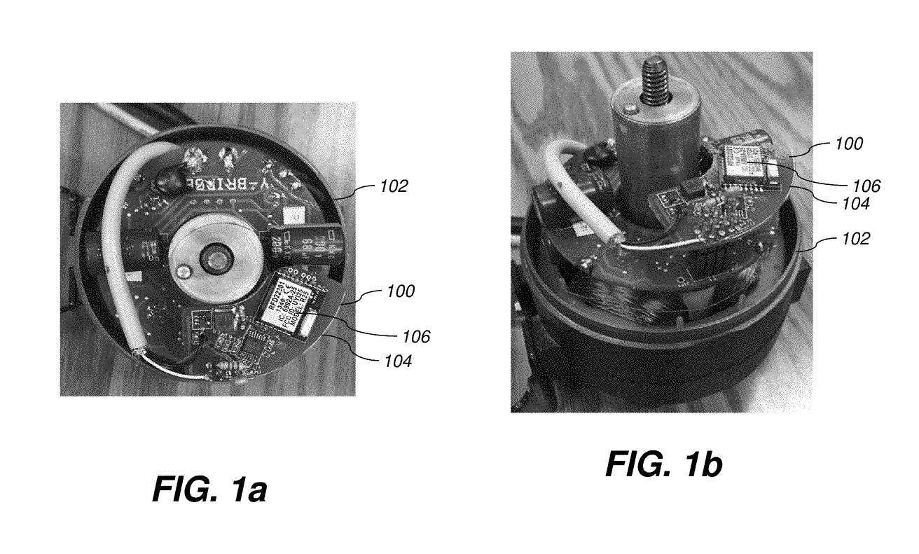

FIG. 1a and 1b show top and perspective views, respectively, of an interface system 100 installed in a housing of a commercially-available ECM 102 according to various aspects. The interface system 100 enables HVAC and refrigeration units to be operated via wireless control using portable devices with a generic software platform that works with multiple operating system (e.g., Android and IOS) environments. The system 100 includes an interface circuit board 104 having radio circuitry which is contained within the ECM 102 motor housing and powered from the existing control circuitry of the ECM 102 without impeding upon its performance for commercial applications.

The system 100 includes a communication module 106, which in one example may be an RFduino RFD22301 bluetooth chipset provided by RFDigital. The communication module 106 provides wireless communication between the interface system 100 and an external controller.

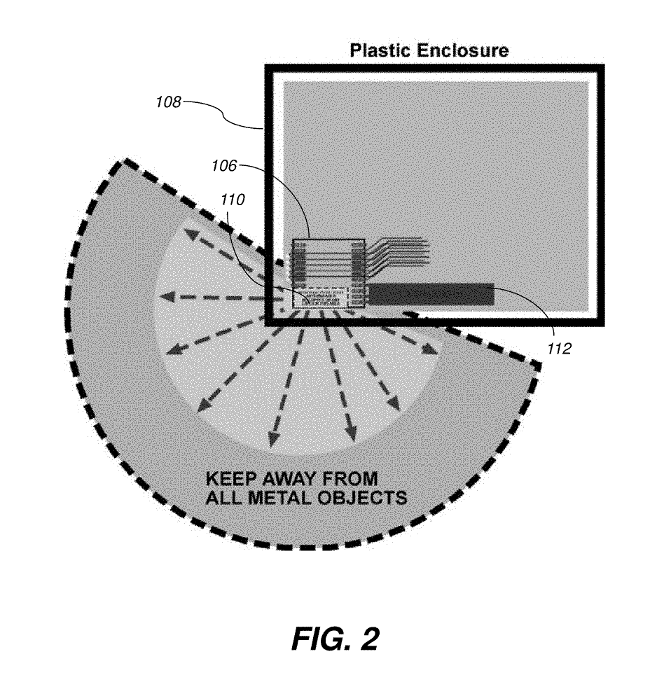

FIG. 2 shows an example of the communication module 106 (RFduino chipset) layout within a plastic enclosure 108. From the example it can be seen that the antenna 110 of the module 106 is best placed at the edge of the enclosure 108 so that no copper or components can interfere with the signal. This also makes the antenna 110 as close as possible to free air space to ensure good signal strength. The one-inch length copper area 112 is optional, however it does improve the range if it is added.

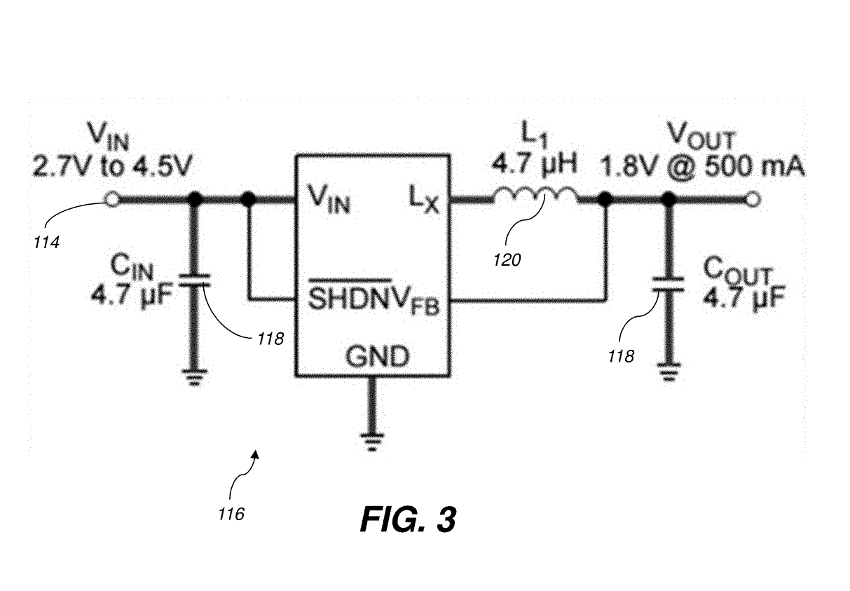

The communication module 106 receives its power from an existing power feed port 114 on the ECM 102. The power from the ECM power feed port 114 is fed to a switching regulator circuit 116 contained within the interface system 100. One example of a suitable switching regulator circuit 116 is shown in FIG. 3. As shown, the switching regulator circuit 116 comprises a switching buck topology, such as a MCP-1603-33I regulator provided by Microchip. The regulator circuit 116 may also include two smoothing shunt capacitors 118 on the input and output lines and a buck inductor 120. In one example, the buck inductor is a 4.7 uH inductor; however, a 3.3 uH inductor may also be used.

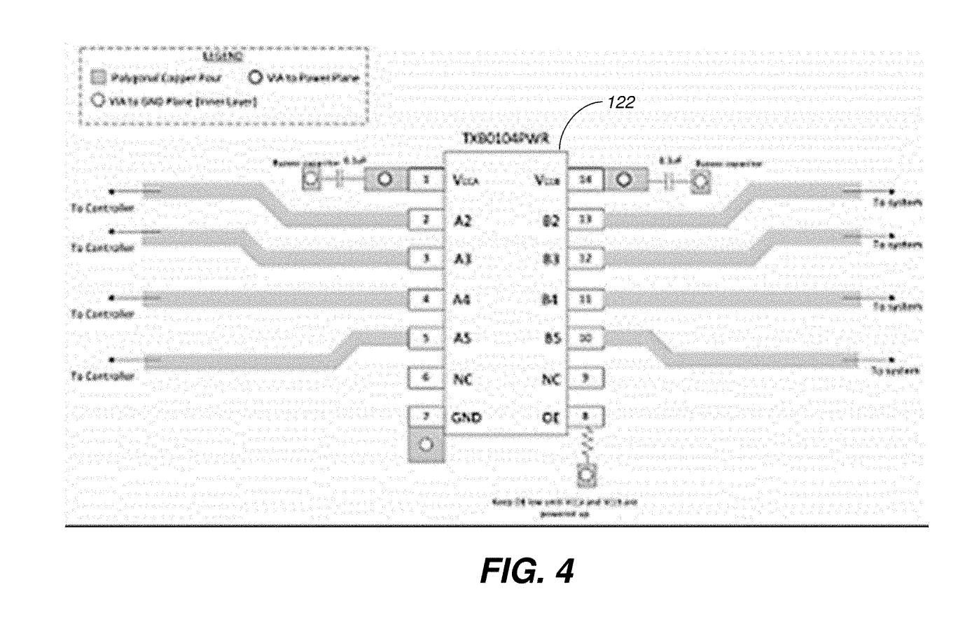

In certain embodiments, the ECM existing control circuitry provides a 5v power source, which is converted to 3V by a voltage level translator. FIG. 4 shows one example of a suitable voltage translator circuit 122, which may comprise a TXB0104 voltage translator supplied by Texas Instruments.

In order to sense the speed of the ECM motor 102 being controlled, the communication module 106 receives a digital square wave signal which represents one-half revolution of the motor. In certain embodiments, the communication module 106 implements a reciprocal frequency counter method to determine the motor speed (rpm) as follows. The controller 106 observes one full period of an input motor speed signal from the existing ECM control circuitry and counts the amount of time that has passed in microseconds. Then, the microseconds count is used to calculate the revolutions per minute of the rotor using equation (1) below.

$$rpm = ( \frac{1}{microseconds per period} ) ⋆ 30 , 000 , 000 \qquad ( 1 )$$

The data resulting from this equation is then wirelessly sent to a handheld device, such as a smartphone, where an application running on the handheld device displays the data. This method provides very accurate and extremely precise readings of the rotor RPM to decimal resolution.

The communication module 106 also receives a temperature sign from the ECM via the existing port on the ECM housing. In order to perform signal processing on the temperature signal from the ECM, it needs to be converted into a useable voltage level after the analog read function is used. In one example, the communication module 106 (i.e., RFduino) has 10 bit resolution for its analog inputs, so the read value needs to be transformed into useable voltage data by using the following conversion seen in equation (2) below.

$$sensor voltage = analog Read ( sensor pin ) ⋆ ( \frac{2.88}{1023} ) \qquad ( 2 )$$

The 2.88 value seen in equation (2) is the peak voltage through a resistive network between the communication module (RFduino) and the temperature sensor. The 1023 value seen in equation (2) is due to the 10 bit resolution of the analog read. Correlation tests in one example yielded equation (3) seen below and was used to relate the sensor voltage to the actual temperature in one example.

$$temperature = ( \frac{( sensor voltage + 9.0175 )}{.2836} ) \qquad ( 3 )$$

The data yielded by equation (3) is then sent to the external handheld unit (e.g., smartphone) for display and also used by the communication module 106 if the user selects the temperature sensing mode. This mode observes the temperature values and change the speed of the motor accordingly, faster for higher temperatures and slower for lower temperatures.

For the receiving code of the communication module 106, the external smartphone application sends out a byte value equalling anywhere from zero to eight. The communication module 106 subtracts one from the received value and then multiplies it by two to obtain the correct hexadecimal speed index value to be sent to the motor to change its speed. This operation ensures that the speed is only changed in 100 rpm increments from 1000 to 1600 rpm. This code can easily be changed to specify 50 rpm increments from 1000 to 3000 rpm, for example. Still other increments and ranges may be used.

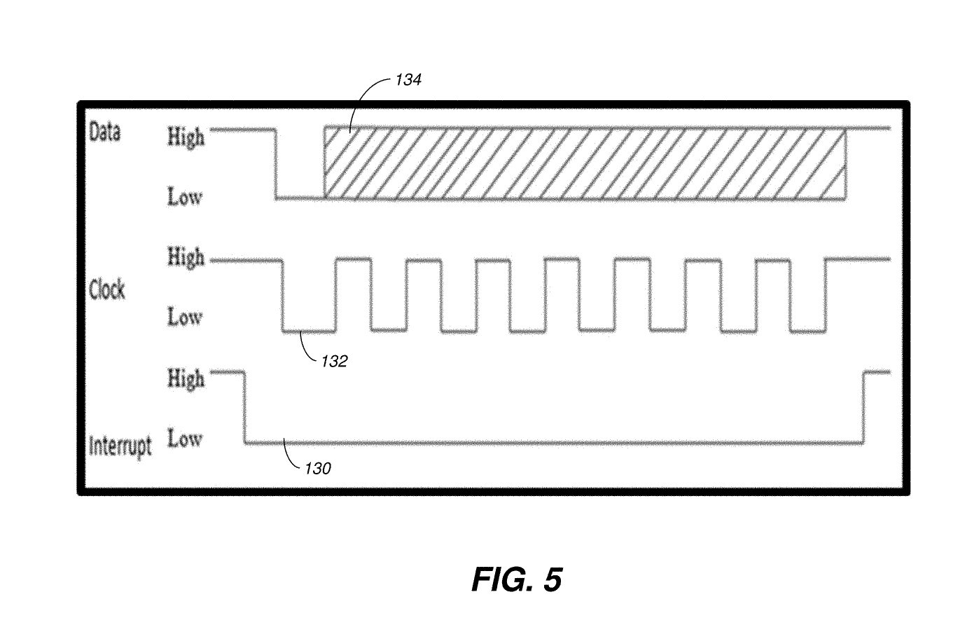

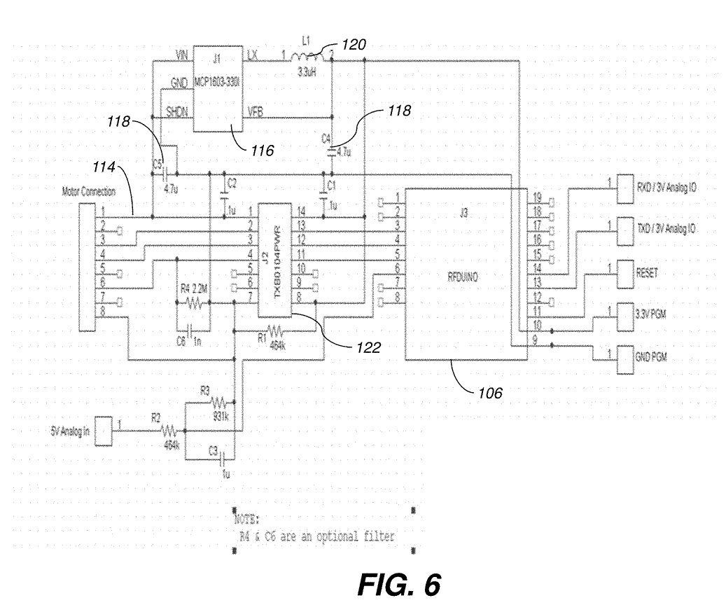

For all modes of operation, once the communication module 106 has determined the correct speed index value to send, it sets an interrupt line 130 low to begin communication with the ECM motor's existing microcontroller (e.g., a PIC16F676) as shown in FIG. 5. It changes the previous speed input pin to a data output pin, sets it low and then sets the clock line 132 low. From this point on, the motor will read the state of the data line 134 (high=1, low=0) on every rising edge of the clock signal 132 from most significant bit to least significant bit until eight bits have been sent. At this point the clock signal 132 will remain high, the data line 134 will be switched back to a signal input and the interrupt line will be brought high to signal the end of the communication. A diagram of the data transmission timing can be seen in FIG. 5.

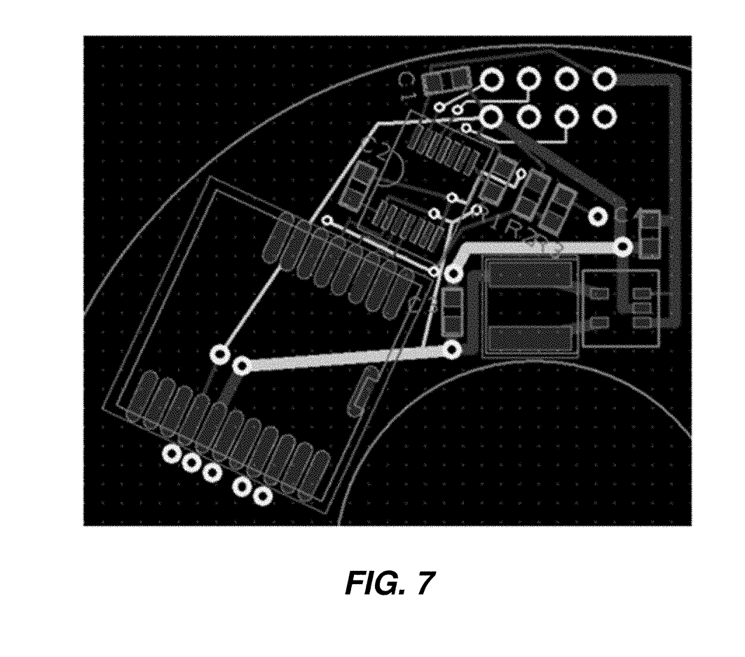

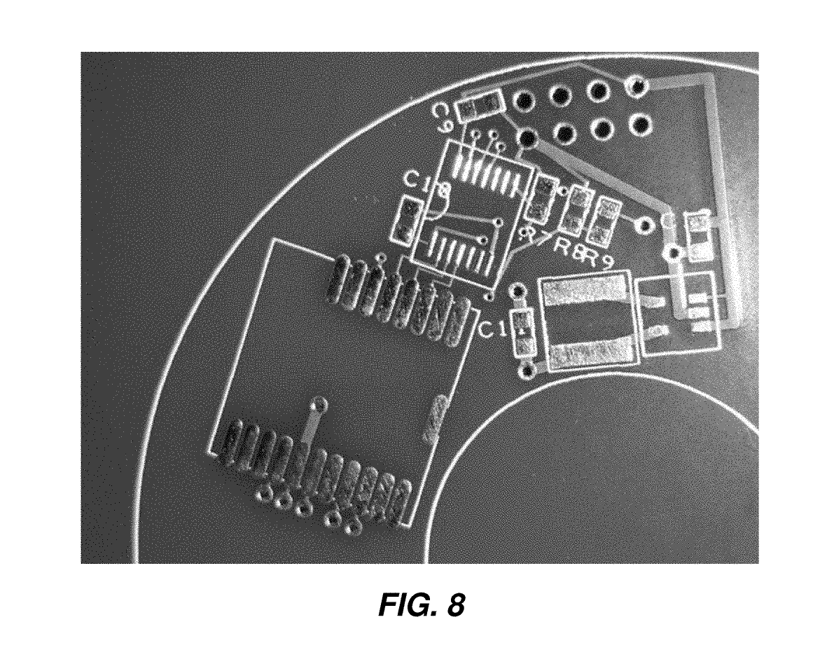

In one example design of a PCB which houses the system components, the most necessary restrictions that needed to be observed and adhered to were those of the antenna, regulator, and level translator. The other main consideration was that the board must fit within the motor housing 108 with the only allowance being that the plastic front cap of the motor 102 could be extended if needed. With all restrictions in consideration an example PCB was laid out in PCB Artist following the radii of the motors control board. The circuit topology was laid out so that the RFduino antenna was close to the outer radius of the board and the majority of the communication pins were close to the 8 pin connection to the motor PCB. The bidirectional voltage level translator was then placed in line between the RFduino communication pins and the 8 pin connection to the motor PCB. The switching regulator 116 was placed as far away from the RFduino antenna without creating excessively large loops as specified its datasheet, and all external components were placed as close as possible to the regulator to minimize the trace length and loops areas. The only larger loops were created by the ground trace to the regulator and the 3.3 volt output line which went to the RFduino and level translator. The 5 volt to 3 volt analog input port for the temperature sensor was laid out in the available space in the center of the board, and the 5 pin programming port/3 volt analog input ports were placed on the furthest side of the RFDuino to allow for in circuit programming and 3 volt inputs. A sample circuit diagram for the interface system is shown in FIG. 7. FIG. 8 shows a sample PCB board layout for the interface system. FIG. 9 shows one example of a manufactured PCB board for the interface system (without components populated).

It shall be understood that the communication module of the interface system may include one or more computer microprocessors, memory, and input/output devices containing non-transitory machine-readable code configured to perform the processes described above.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects These aspects can all generally be referred to herein as a “service,” “circuit,” “circuitry,” “module,” or “system.”

Furthermore, various aspects herein may be embodied as computer program products including computer readable program code stored on a tangible non-transitory computer readable medium connected to the processor. The program code includes computer program instructions that can be loaded into processor), to cause functions, acts, or operational steps of various aspects herein to be performed by the processor 186 (or other processor). Computer program code for carrying out operations for various aspects described herein may be written in any combination of one or more programming language(s).

The invention is inclusive of combinations of the aspects described herein. References to “a particular aspect” and the like refer to features that are present in at least one aspect of the invention. Separate references to “an aspect” (or “embodiment”) or “particular aspects” or the like do not necessarily refer to the same aspect or aspects; however, such aspects are not mutually exclusive, unless so indicated or as are readily apparent to one of skill in the art. The use of singular or plural in referring to “method” or “methods” and the like is not limiting. The word “or” is used in this disclosure in a non-exclusive sense, unless otherwise explicitly noted.

The invention has been described in detail with particular reference to certain preferred aspects thereof, but it will be understood that variations, combinations, and modifications can be effected by a person of ordinary skill in the art within the spirit and scope of the invention.

1. A motor control interface system, comprising:
an interface communication module configured to connect to a wired control port of a rotating electronically controlled motor, wherein the interface communication module converts a rotating motor speed signal to a wireless signal for receipt by an external monitoring device;
wherein the speed output signal comprises a digital square wave signal; and
wherein the communication module implements a reciprocal frequency counter method to determine the speed of the motor.

2. The system of claim 1, further comprising a bidirectional switch-mode dc-dc converter operatively connected between the communication module and the wired control port of the motor.

3. The system of claim 1, the communication module is programmed to interface with a plurality of operating systems of the external monitoring device.

4. The system of claim 1, wherein the external monitoring device is a smart phone.

5. The system of claim 1, further comprising an antenna operatively connected to the communication module, the antenna positioned to provide maximum communication distance without interference from metallic components of the motor or a motor control unit of the motor.

6. The system of claim 1, wherein the antenna is positioned near an edge of the communication module.

7. The system of claim 1, wherein the rotating electronically controlled motor is part of an HVAC system.

8. The system of claim 1, wherein the rotating electronically controlled motor is part of a refrigeration system.

9. The system of claim 1, wherein the rotating electronically controlled motor is part of an underground water pumping system.

10. A method for controlling an electronically controlled motor, comprising:
wirelessly outputting a rotating motor speed signal from an interface communication module connected to a wired control port of a rotating electronically controlled motor, wherein the interface communication module converts the rotating motor speed signal to a wireless signal for receipt by an external monitoring device;
wherein the speed output signal comprises a digital square wave signal; and
wherein the interface communication module implements a reciprocal frequency counter method to determine the speed of the motor.

11. The method of claim 10, wherein the external monitoring device is a smart phone.

12. The method of claim 10, wherein the rotating electronically controlled motor is part of an HVAC system.

13. The method of claim 10, wherein the rotating electronically controlled motor is part of a refrigeration system.

14. The method of claim 10, wherein the rotating electronically controlled motor is part of an underground water pumping system.
